(19) United States
(12) Patent Application Publication
(10) Pub. No.: US 2013/0081554 A1
(43) Pub. Date: Apr. 4, 2013

(54) DISTRIBUTION OF STARCH IN COMPOSITION OF BUILDING PRODUCTS

(71) Applicant: USG Interiors, LLC, Chicago, IL (US)

(72) Inventor: Bangji Cao, Naperville, IL (US)

(73) Assignee: USG Interiors, LLC, Chicago, IL (US)

(21) Appl. No.: 13/621,406

(22) Filed: Sep. 17, 2012

Related U.S. Application Data
(60) Provisional application No. 61/542,520, filed on Oct. 3, 2011.

(51) Int. Cl. C08L 3/00; C08L 1/00; B05D 7/00

(52) U.S. Cl. 106/204.01; 427/384; 106/206.1; 106/217.01; 106/217.2

(57) ABSTRACT

Building panels such as ceiling tiles have compositions including starch as a binder and a coagulant for the starch. The building panels also can include a fibrous material and a filler. In one aspect, the starch is coagulated by the coagulant resulting in the starch being distributed substantially uniformly through a thickness of the building panels, whereby certain physical properties of the building panels and a wet-felting process for manufacturing the building panels are improved. The coagulant can comprise at least one aluminum salt. In the wet-felting process for manufacturing the ceiling tiles, a slurry comprising an aqueous dispersion of at least one fibrous material, at least one filler material, at least starch as a binder and a coagulant for the starch is delivered onto a foraminous wire frame. The slurry is dewatered to form a basemat and the basemat is dried to remove any residual moisture.

This application claims the benefit of U.S. provisional patent application Ser. No. 61/542,520, filed Oct. 3, 2011.

### FIELD OF THE INVENTION

The present invention generally concerns the use of starch as a binder in the compositions of building products. In particular the present invention relates to the improved distribution and retention of the starch in building panels such as ceiling tiles for example.

### BACKGROUND OF THE INVENTION

Building products including building panels such as ceiling tiles, for example, can include starch in their compositional makeups. At least one of the functions of the starch is to bind together other components of the building products' compositions. For example, a composition comprising starch granules along with fibrous materials and fillers can be used in the production of ceiling tiles in a wet-felting process. In that process, an aqueous slurry that includes fibers, fillers and binders, such as starch for example, is deposited on a moving foraminous wire frame. Water initially is drained by gravity from the slurry as deposited on the foraminous wire frame and additional dewatering can be performed by vacuum suction and/or pressing operations so as to form a wet basemat. Residual moisture in the wet basemat is removed, typically by introducing the wet basemat into an oven or kiln in which the wet basemat is heated. The dried basemat can thereafter be subjected to finishing operations in which the dried basemat can be divided into individual tiles for example. Other finishing operations that can be carried out include grinding, perforating, fissuring, coating and edge cutting. The starch can provide flexural strength and hardness to the ceiling tile.

### SUMMARY OF THE INVENTION

It has been determined that, in the production of building products including building panels such as ceiling tiles for example in which a wet-felting process is employed and particulate starch is included in the slurry from which the building products are formed, the starch in the final products can be distributed unevenly in the so-called z direction, or along the z axis, of the products, i.e., through the thickness of the products, and an undesirable amount of the starch is lost, i.e., not retained, in the wet felting process .

According to one aspect of the present invention, a building panel configured to be incorporated into a structure has a composition that includes starch as a binder and a coagulant for the starch, i.e., an agent that that causes coagulation of the starch.

According to another aspect, the starch is distributed substantially uniformly through a thickness of the building panel.

According to an additional aspect, the coagulant can comprise at least one aluminum salt such as aluminum sulfate, polyaluminum chloride and sodium aluminate for example.

According to a further aspect, the composition of the panel can include at least one fibrous material and at least one filler material wherein the at least one fibrous material can comprise mineral wool, slag wool, rock wool, stone wool, fiber glass and a cellulosic material for example and the at least one filler material can comprise calcium carbonate, clay, gypsum and expanded perlite for example.

According to still another aspect, the building panel can comprise a ceiling tile.

According to yet another aspect, a method of producing ceiling tiles can include providing a slurry comprising an aqueous dispersion of at least one fibrous material, at least one filler material, at least starch as a binder and a coagulant for the starch. The slurry is delivered onto a foraminous wire frame after which the slurry is dewatered to form a basemat. The basemat is dried to remove any residual moisture. The starch is distributed substantially uniformly through a thickness of the basemat and the ceiling tile, and the starch included in the slurry is substantially retained in the basemat and the ceiling tiles.

In the method of producing the ceiling tiles, the coagulant can comprise at least one aluminum salt such as aluminum sulfate, polyaluminum chloride and sodium aluminate for example.

Also in the method of producing the ceiling tiles, the at least one fibrous material can comprise mineral wool, slag wool, rock wool, stone wool, fiber glass and a cellulosic material for example and the at least one filler material can comprise calcium carbonate, clay, gypsum and expanded perlite for example.

According to still an additional aspect, the coagulant (100% active) can be present in a building panel such as ceiling tile in an amount ranging from approximately 0.1% to approximately 4.0% by weight of the building panel. In an embodiment of this aspect, the coagulant (100% active) can be present in the building panel in an amount ranging from approximately 0.4% to approximately 0.8% by weight of the building panel.

### BRIEF DESCRIPTION OF THE DRAWINGS

The foregoing and other aspects are better understood when the following detailed description is read with reference to the accompanying drawings in which:

FIG. 1 comprises a graph that shows the distribution profile of starch through the thickness of conventional ceiling tiles;

FIG. 2 comprises a graph that shows the relative concentrations of starch at the top, middle and bottom of conventional ceiling tiles;

FIG. 3 comprises a graph that shows the improved distribution and retention of starch in ceiling tiles that results from the inclusion of a coagulant for the starch;

FIG. 4 comprises a graph that shows the improved retention of starch in ceiling tiles that results from the inclusion of a coagulant for the starch;

FIG. 5 comprises a graph that shows the improvement in the modulus of rupture of ceiling tiles that results from the inclusion of a coagulant for the starch contained in the ceiling tiles; and

FIG. 6 comprises a graph that shows the improvement in the hardness of ceiling tiles that results from the inclusion of a coagulant for the starch contained in the ceiling tiles.

### DETAILED DESCRIPTIONS OF ASPECTS, EMBODIMENTS AND EXAMPLES

Embodiments and examples that incorporate one or more aspects of the present invention are described below. These embodiments and examples are not intended to be limitations on the present invention. Thus, for example, in some instances, one or more described aspects, embodiments or examples of the present invention can be utilized in other aspects, embodiments and examples. In addition, certain terminology is used herein for convenience only and is not to be taken as limiting the present invention.

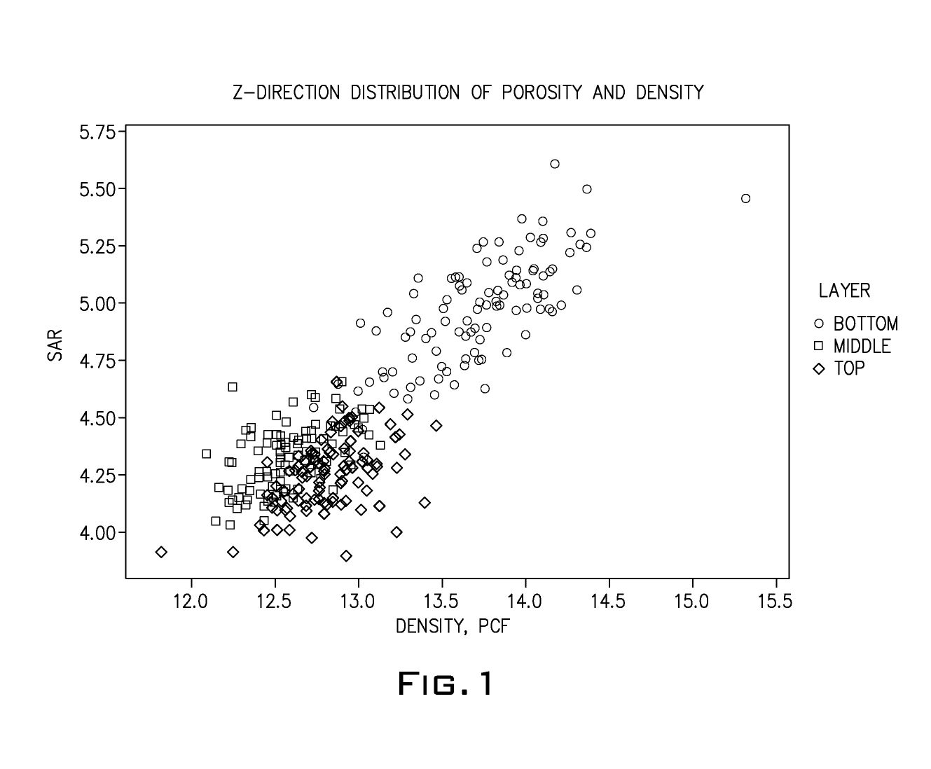

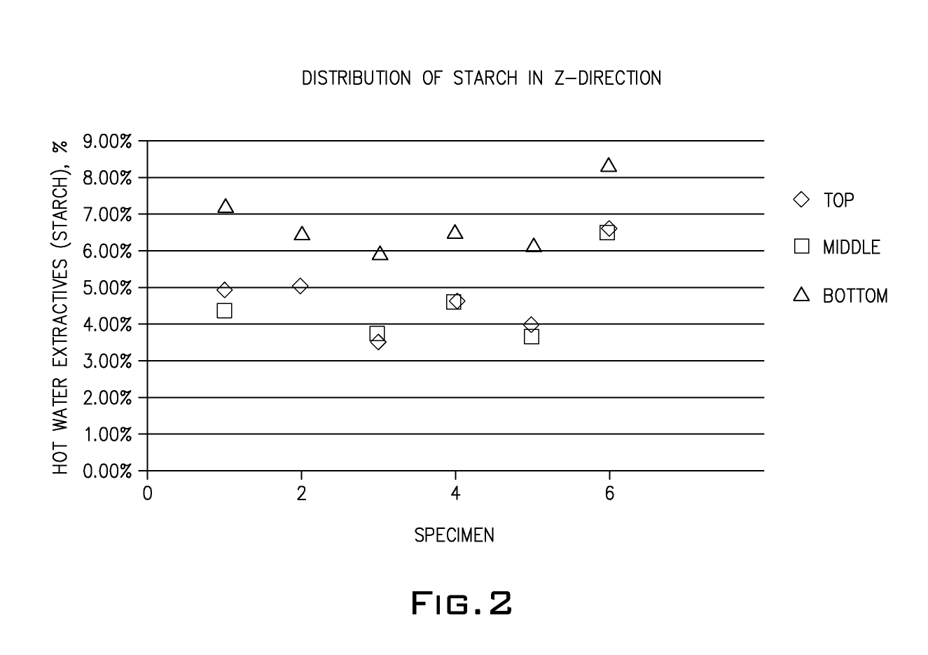

It has been determined that, in the production of building products comprising, for example, building panels such as ceiling tile in which a wet-felting process is employed and particulate starch is included as a binder in a slurry comprising one or more fibrous materials and one or more filler materials from which the building panels are formed, the starch in the final products can be distributed unevenly in the so-called z direction or along the z axis of the products, i.e., through the thickness of the products. The graphs of FIG. 1 and FIG. 2 illustrate this effect.

In the graphs of FIG. 1 and FIG. 2, data is presented concerning the relative amounts of starch that are present in the top, middle and bottom portions of ceiling tiles made in a wet-felting process, wherein the starch is used as a binder for fibrous and filler materials included in the compositional make-up of the ceiling tiles. In the wet-felting process of manufacturing the ceiling tiles from which the data contained in FIG. 1 and FIG. 2 was developed, a slurry of the binder and the fibrous and filler materials was delivered to a moving foraminous wire frame, a wet basemat was formed on the foraminous wire frame and the wet basemat was dried to remove residual moisture and form the ceiling tiles. The ceiling tiles were sliced in a direction parallel to their thickness, or perpendicular to the z axis of the ceiling tiles, into three layers to produce samples of the top, middle and bottom portions or layers of the ceiling tiles.

In the graph of FIG. 1, the specific air-flow resistivity (SAR) values, measured in million Pascal-seconds/square meter, of the samples are plotted along the y or ordinate axis and the density values, measured in pounds per cubic foot (PCF), of the samples are plotted along the x axis or abscissa. As shown in the graph of FIG. 1, both the SAR values and the density values for samples taken from the top portions of the ceiling tiles, indicated by the circular data points, were greater than the SAR values and density values for the samples taken at the middle portions of the ceiling tiles, indicated by the square data points; and both the SAR values and the density values for samples taken at the middle portions of the ceiling tiles, indicated by the square data points, were greater than the SAR values and density values for the samples taken at the top portions of the ceiling tiles, indicated by the diamond data points.

The higher density values and higher SAR values of the samples taken at the bottom layers of the ceiling tiles are an indication that more fine particles are present at the bottom portions of ceiling tiles made in a wet-felting process than at the top and middle portions of the ceiling tiles. The graph of FIG. 2 confirms that, to a significant extent, the fine particles at the bottom portions of the ceiling tiles comprise starch particles. Starch particles are the only water soluble constituent of the ceiling tiles' compositions at water temperatures in the range of 70° C. to 100° C. and, therefore, an analytical test using hot water in that temperature range to dissolve the starch in the samples taken from the top, middle and bottom portions of the ceiling tiles was used to determine the amounts of starch present in each of those portions of the ceiling tiles. In the graph of FIG. 2, the amount of starch present in six samples, expressed as a percentage of the total amount of materials present in the samples, is plotted along the y or ordinate axis and the data for the six samples, numbered 1 through 6, examined for their starch content, is set forth along the x axis or abscissa of FIG. 2. As shown in the graph of FIG. 2, there was a higher percentage of starch in the bottom portions of the samples of the ceiling tiles than in the middle portions of the samples of the ceiling tiles; and there was a higher percentage of starch in the middle portions of the samples of the ceiling tiles than in the top portions of the samples of the ceiling tiles.

While not intending to be bound by any particular explanation of the mechanism that causes the starch to be present in greater amounts at the bottom portions of ceiling tiles produced by the wet-felting process, it can be the case that as water begins to drain through the foraminous wire frame from the slurry of starch, fibrous material and filler material from which the basemat is formed, the fibrous materials are the first to be filtered out at and deposited on the foraminous wire frame. The particulate materials in the slurry, and particularly the starch particles, are much more mobile due to their size and shape. Therefore the particulate materials, including the starch particles, flow downwardly together with the water in which they are suspended until they are captured between the interstices in the network formed by the fibrous materials. Because the starch particles can be very fine, some of the starch particles will pass through this network and through the foraminous wire frame and not be retained. In any event, as a result of this hydraulic action, a concentration gradient will be created with respect to the starch in the z direction or along the z axis of the basemat and the subsequently produced ceiling tiles, as demonstrated by the graphs of FIG. 1 and FIG. 2.

The greater amounts of starch present at the bottom portions of ceiling tiles can present issues both as to the physical properties of the ceiling tiles as well as to the production of the ceiling tiles. For example, the settling of excess fine starch particles at the bottom of basemat as it is being formed can decrease the porosity of the bottom portion of the basemat, thus hindering the flow of water and reducing the speed of drainage of the water. As a result, the water load in the wet basemat is increased and the increased water load can result in greater demands at the subsequent drying operations to which the wet basemat is subjected. Additionally, for example, the lesser starch contents at the top and middle of the basemat and, consequently, at the face and middle portion of the final ceiling tiles can reduce the compression resistance of the core of the ceiling tiles and the tensile strength of the face of the ceiling tiles. Because the flexural strength of the final ceiling tiles is proportional to the overall compression resistance of the core of the ceiling tiles and the tensile strength of the face of the ceiling tiles, the poor distribution of the starch in the z direction of the ceiling tiles can reduce the flexural strength of the ceiling tiles. Other deleterious consequences also can result from the poor distribution of starch in the z direction of the ceiling tiles. In addition, the passage of quantities of starch out of the slurry and through the foraminous wire frame as the basemat is formed and the failure of the starch to be retained represents a cost burden in the production process.

The distribution of starch in the z direction of the ceiling tiles and the retention of the starch can be improved and the negative aspects of the unequal distribution of the starch avoided by adding a coagulant for the starch to the compositions of the ceiling tiles. In the case of the wet-felting method of manufacturing the ceiling tiles, the coagulant is included in the slurry that is delivered to the foraminous wire frame. The coagulant acts to coagulate the starch and, as a result, the starch is aggregated into sufficiently large agglomerations to be retained by the network of fibrous materials that is initially formed at the foraminous wire frame. As a result, the starch is not carried through the network to any excessive extent by the draining water and is substantially uniformly distributed in the z direction through the thickness of the ceiling tiles.

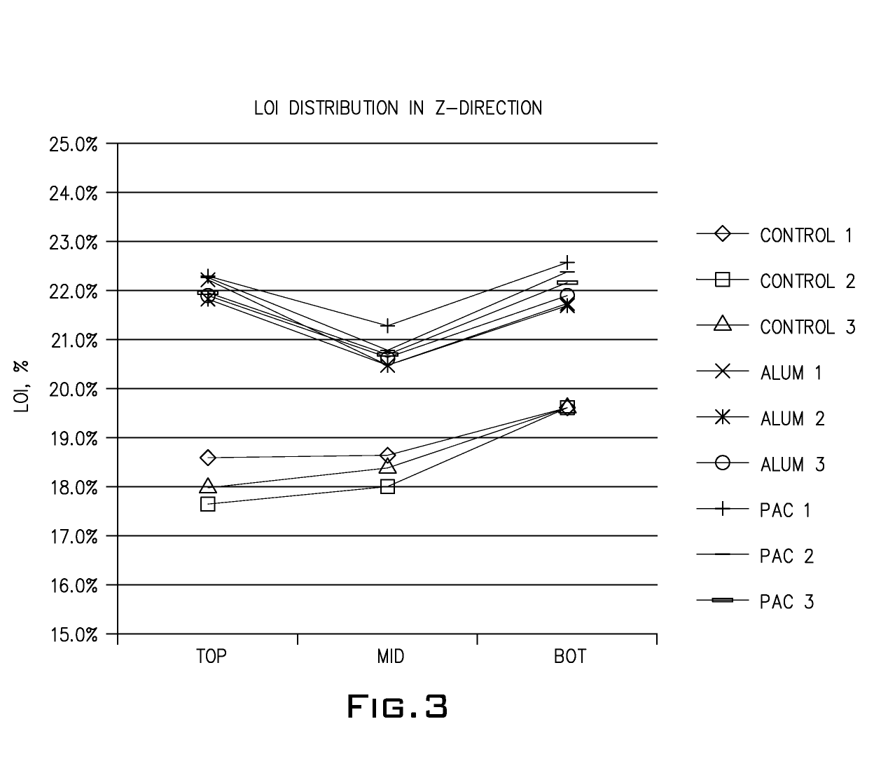

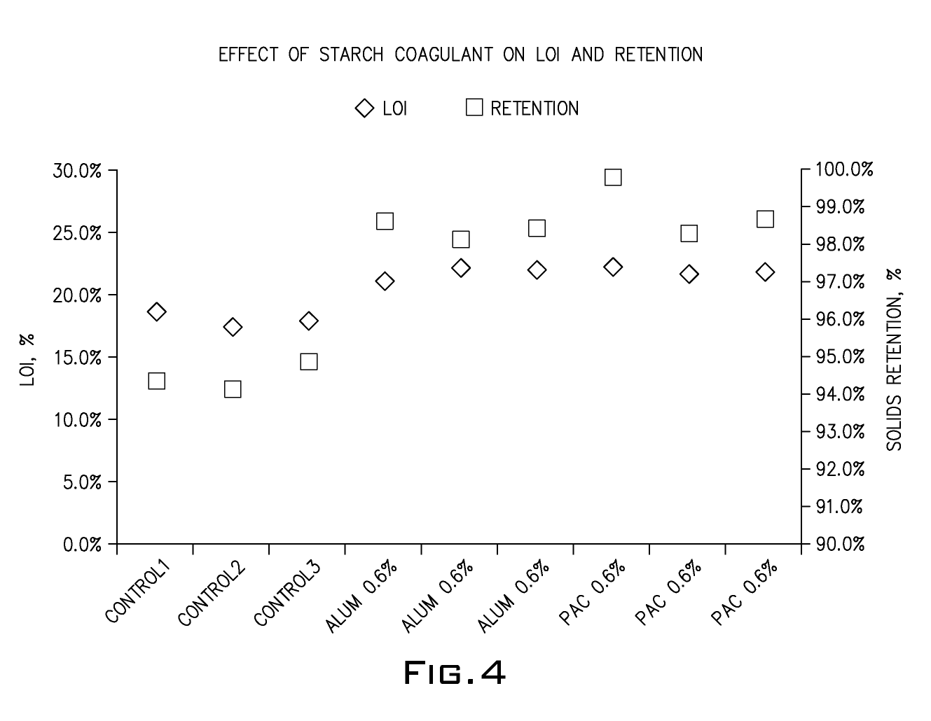

The improved distribution of starch in the z direction of the ceiling tiles and the improved retention of the starch that results from the use of a starch coagulant is evidenced by the graphs of FIGS. 3 and 4. The data presented in FIG. 3 was developed from: a first group of ceiling tile samples that did not include a coagulant for the starch and are identified in FIG. 3 as “Control 1,” “Control 2” and “Control 3;” a second group of ceiling tile samples that included aluminum sulfate (alum) as a coagulant for the starch and are identified in FIG. 3 as “Alum 1,” “Alum 2” and “Alum 3;” and a third group of ceiling tile samples that included polyaluminum chloride (PAC) as a coagulant for the starch and are identified in FIG. 3 as “PAC 1,” “PAC 2” and “PAC 3.” All the ceiling tiles from which the samples were taken were produced in a wet-felting process and the amount of starch included in the slurries from which the ceiling tiles were made was substantially the same. The ceiling tiles included approximately 36% mineral wool by weight.

Each of the ceiling tiles was separated into top, middle and bottom portions or layers, expressed by the designations “Top,” “Mid” and “Bot,” respectively, appearing along the x axis or abscissa of the graph of FIG. 3, by cutting the ceiling tiles into samples in a direction perpendicular to the z axis of the ceiling tiles. Thereafter, each of the samples was subjected to a standard loss on ignition (LOI) test to determine the amount of organic materials present in the samples and the LOI values are set forth along the y or ordinate axis of the graph of FIG. 3. The only organic material, in addition to the starch, that was present in the ceiling tiles from which the samples were taken were cellulosic fibers and it is known that the distribution of the cellulosic fibers is essentially constant through the thickness of the ceiling tiles. Therefore, the LOI values plotted in the graph of FIG. 3 for the various samples are indicative of the relative amounts of starch that are present in the top, middle and bottom portions of the ceiling tiles.

As can be seen from the graph of FIG. 3, the amounts of starch present in the bottom portions of the samples of the ceiling tiles that did not include a starch coagulant (“Control 1,” “Control 2” and “Control 3”) were greater than the amounts of starch present in the middle and top portions of the samples. On the other hand, the amounts of starch present in the bottom portions of the each of the samples of the ceiling tiles that included a coagulant for the starch (“Alum 1,” “Alum 2,” “Alum 3,” “PAC 1,” “PAC 1,” “PAC 2” and “PAC 3”) were substantially equal to the amounts of starch present in the respective top portions of the samples and only somewhat greater than the amounts of starch present in the respective middle portions of the samples. This, of course, is an indication that the starch was substantially uniformly distributed in the z direction, or through the thickness, of the ceiling tiles that included a starch coagulant. In addition, the amounts of starch present in each of the samples that included a starch coagulant were greater than the amounts of starch present in each of the samples that did not include a starch coagulant. This is an indication that the starch is retained to a greater extent in the ceiling tiles that included the starch coagulant.

The improved retention of starch in the z direction of the ceiling tiles, which is an indication of improved distribution of the starch that results from the use of a starch coagulant, is also evidenced by the graph of FIG. 4. The data presented in FIG. 4 was developed from: a first group of three ceiling tile samples that did not include a coagulant for the starch and are identified in FIG. 4 as “Control 1,” “Control 2” and “Control 3;” a second group of three ceiling tile samples that included aluminum sulfate (alum) as a coagulant for the starch and are identified in FIG. 4 as “Alum 0.6%;” and a third group of three ceiling tile samples that included polyaluminum chloride (PAC) as a coagulant for the starch and are identified in FIG. 4 as “PAC 0.6%.” A listing of these nine samples appears along the x axis or abscissa of the graph of FIG. 4. The “0.6%” designations indicate that the amounts of coagulant added to the compositions of the ceiling tiles were approximately 0.6% of the total weight of the compositions. All the ceiling tiles from which the samples were taken were produced in a wet-felting process and the amounts of starch included in the slurries from which the ceiling tiles were made was substantially the same. The ceiling tiles included approximately 36% mineral wool.

Each of the samples was subjected to a standard loss on ignition test to determine the total amounts of organic materials, including starch, that were present in the samples. As described above, the only organic material, in addition to the starch, that was present in the ceiling tiles from which the samples were taken were cellulosic fibers and it is known that the distribution of the cellulosic fibers is essentially constant through the thickness of the ceiling tiles. Therefore, the LOI values plotted in the graph of FIG. 4 for the various samples are indicative of the relative amounts of starch that are present in the ceiling tile samples. In the graph of FIG. 4, the loss on ignition (LOI), or the weight of the organic materials consumed in the loss on ignition tests, expressed as a percentage of the total weights of the samples, is plotted along a left-side y or ordinate axis of the graph and the amounts of total solids, including starch, retained in the ceiling tiles (Solids Retention, %) are plotted along a right side y or ordinate axis of the graph.

As shown in the graph of FIG. 4, the LOI values for the samples that contained the starch coagulant (“Alum 0.6%” and “PAC 0.6%”) were greater than the LOI values for the samples that did not include a starch coagulant (“Control 1,” “Control 2” and “Control 3”). At the same time, the Solids Retention values for the samples that contained the starch coagulant (“Alum 0.6%” and “PAC 0.6%”) were greater than the Solids Retentions values for the samples that did not include a starch coagulant (“Control 1,” “Control 2” and “Control 3”). These results taken together are an indication that the starch was substantially retained in the ceiling tiles that included a starch coagulant and, therefore, substantially uniformly distributed in the z direction, or through the thickness, of the ceiling tiles that included a starch coagulant.

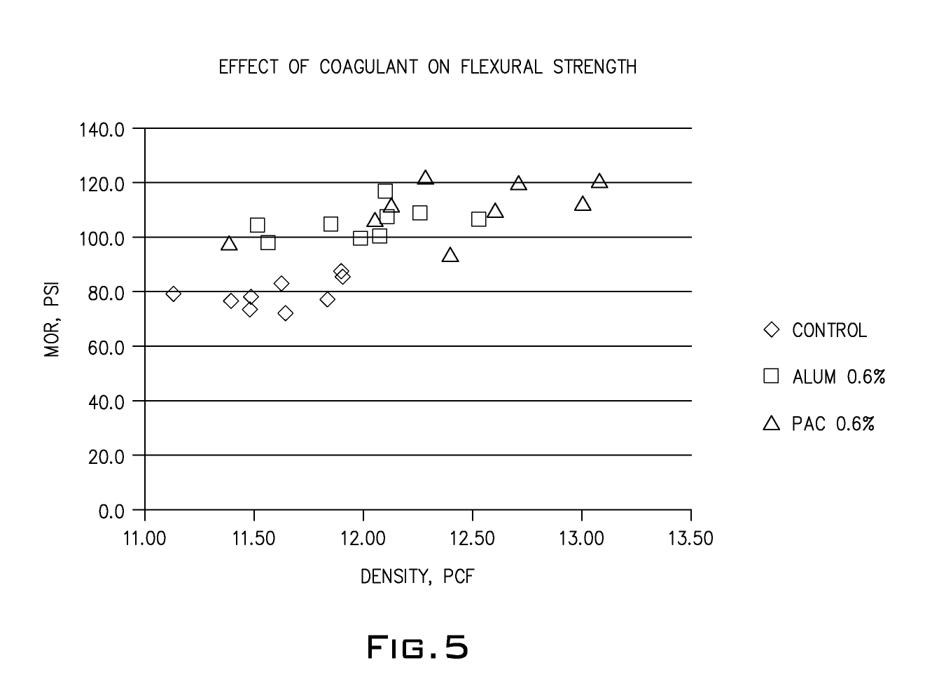

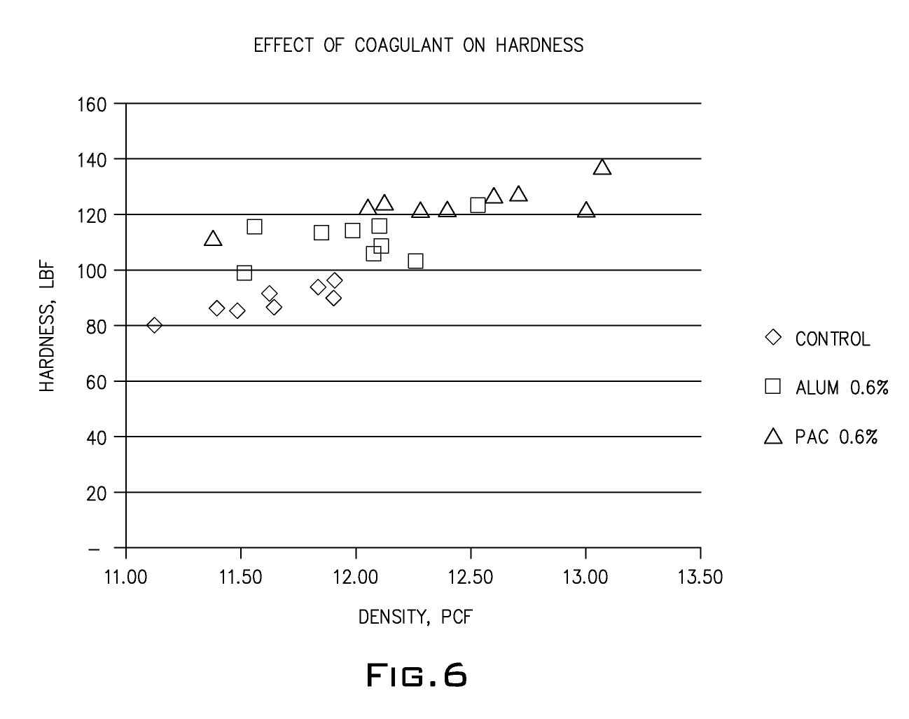

The improvements in the distribution and retention of the starch in the ceiling tiles are responsible for imparting improved flexural strength and improved hardness to the ceiling tiles. These beneficial effects are evidenced by the graphs of FIG. 5 and FIG. 6. In the graph of FIG. 5, the modulus of rupture (MOR) in pounds per square inch for a number of ceiling tile samples is plotted along the y or ordinate axis and the density in pounds per cubic foot (pcf) of the samples is plotted along the x axis or abscissa. The data points on the graph represented by the diamond symbols comprise values for ceiling tile samples that did not include a coagulant for the starch; the data points on the graph represented by the square symbols comprise values for ceiling tile samples that included aluminum sulfate (alum) in the amount of 0.6% by weight of the constituents of the ceiling tile samples; and the data points on the graph represented by the triangular symbols comprise values for ceiling tile samples that included polyaluminum chloride (PAC) in the amount of 0.6% by weight of the constituents of the ceiling tile samples. As is demonstrated by the graph of FIG. 5, the modulus of rupture values for the ceiling tile samples that included a coagulant for the starch were substantially greater than the modulus of rupture values for the samples that did not include a coagulant for the starch.

In the graph of FIG. 6, the hardness in pound-feet (lbf) for a number of ceiling tile samples is plotted along the y or ordinate axis and the density in pounds per cubic foot (pcf) of the samples is plotted along the x axis or abscissa. The data points on the graph represented by the diamond symbols comprise values for ceiling tile samples that did not include a coagulant for the starch; the data points on the graph represented by the square symbols comprise values for ceiling tile samples that included aluminum sulfate (alum) in the amount of 0.6% by weight of the constituents of the ceiling tiles; and the data points on the graph represented by the triangular symbols comprise values for the ceiling tile samples that included polyaluminum chloride (PAC) in the amount of 0.6% by weight of the constituents of the ceiling tiles. As is demonstrated by the graph of FIG. 6, the hardness of the ceiling tile samples that included a coagulant for the starch was substantially greater than the hardness of the samples that did not include a coagulant for the starch.

The beneficial results that can be experienced by the addition of a coagulant for the starch are present for virtually any concentration of the coagulant. According to one aspect, the coagulant is included in the ceiling tiles in amounts ranging from approximately 0.1% to approximately 4.0% by weight of the ceiling tile components. In an embodiment of this aspect, coagulant concentrations ranging from approximately 0.4% to approximately 0.8% by weight of the ceiling tile components are employed.

The present invention has application to building products including building panels comprising, for example, ceiling tiles that can be incorporated into structures such as commercial and industrial buildings and home residences for example. In one aspect of the present invention, a building panel configured to be incorporated into a structure has a composition that includes starch as a binder and a coagulant for the starch. In another aspect, the coagulant comprises at least one aluminum salt. In an additional aspect, the aluminum salt is selected from the group consisting of aluminum sulfate, polyaluminum chloride and sodium aluminate. In an additional aspect the starch is distributed substantially uniformly through a thickness of the building panel. In one embodiment of the foregoing aspects, the composition of the building panel includes at least one fibrous material and at least one filler material. In a particular example of this embodiment, the at least one fibrous material is selected from the group consisting of mineral wool, slag wool, rock wool, stone wool, fiber glass and a cellulosic material and the at least one filler material is selected from the group consisting of calcium carbonate, clay, gypsum and expanded perlite. In another example of the foregoing aspects, embodiments and examples, the building panels comprise ceiling tiles. In additional embodiments of the foregoing aspects, the building panels, including ceiling tiles, include at least one aluminum salt in an amount ranging from approximately 0.1% to approximately 4.0% by weight of the ceiling tile components and in a particular example of this embodiment, the at least one aluminum salt is present in an amount from approximately 0.4% to approximately 0.8% by weight of the ceiling tile components.

In still another aspect, a ceiling tile includes in its compositional make-up at least one fibrous material, at least one filler material and at least starch as a binder, the starch being distributed substantially uniformly through a thickness of the ceiling tile. In an example of this aspect, the at least one fibrous material is selected from the group consisting of mineral wool, slag wool, rock wool, stone wool, fiber glass and a cellulosic material and the at least one filler material is selected from the group consisting of calcium carbonate, clay, gypsum and expanded perlite. In an embodiment of the aspect, the composition of the ceiling tile includes a coagulant for the starch. In an example of the embodiment, the coagulant for the starch comprises at least one aluminum salt. In an additional example, the at least one aluminum salt is selected from the group consisting of aluminum sulfate, polyaluminum chloride and sodium aluminate.

The building panels, and in particular the ceiling tiles, can be produced in a wet-felting process. Thus, according to one aspect, a method of producing a ceiling tile includes providing a slurry comprising an aqueous dispersion of at least one fibrous material, at least one filler material, at least starch as a binder and a coagulant for the starch, delivering the slurry onto a foraminous wire frame, dewatering the slurry to form a basemat and drying the basemat to remove any residual moisture, whereby the starch is distributed substantially uniformly though a thickness of the basemat and the ceiling tile and the starch included in the slurry is substantially retained in the basemat and the ceiling tile. In an embodiment of this aspect, the at least one fibrous material is selected from the group consisting of mineral wool, slag wool, rock wool, stone wool, fiber glass and a cellulosic material and the at least one filler material is selected from the group consisting of calcium carbonate, clay, gypsum and expanded perlite. In another embodiment, the coagulant comprises at least one aluminum salt. In an example of this embodiment, the at least one aluminum salt is selected from the group consisting of aluminum sulfate, polyaluminum chloride and sodium aluminate.

While the present invention has been described above and illustrated with reference to certain embodiments thereof, it is to be understood that the invention is not so limited. In addition, modifications and alterations of the aspects of the invention described herein will occur to those skilled in the art upon reading and understanding the specification, including the drawings. The present invention is intended to cover and include any and all such modifications and variations to the described embodiments that are encompassed by the following claims.

What is claimed is:

1. A building panel configured to be incorporated into a structure, the composition of the building panel including starch as a binder and a coagulant for the starch.

2. The building panel of claim 1 wherein the starch is distributed substantially uniformly through a thickness of the building panel.

3. The building panel of claim 1 wherein the building panel comprises a ceiling tile.

4. The building panel of claim 1 wherein the coagulant comprises at least one aluminum salt.

5. The building panel of claim 4 wherein the composition of the building panel includes at least one fibrous material and at least one filler material.

6. The building panel of claim 5 wherein the at least one fibrous material is selected from the group consisting of mineral wool, slag wool, rock wool, stone wool, fiber glass and a cellulosic material and the at least one filler material is selected from the group consisting of calcium carbonate, clay, gypsum and expanded perlite.

7. The building panel of claim 6 wherein the building panel comprises a ceiling tile.

8. The building panel of claim 4 wherein the at least one aluminum salt is selected from the group consisting of aluminum sulfate, polyaluminum chloride and sodium aluminate.

9. The building panel of claim 8 wherein the composition of the building panel includes at least one fibrous material and at least one filler material.

10. The building panel of claim 9 wherein the at least one fibrous material is selected from the group consisting of mineral wool, slag wool, rock wool, stone wool, fiber glass and a cellulosic material and the at least one filler material is selected from the group consisting of calcium carbonate, clay, gypsum and expanded perlite.

11. The building panel of claim 10 wherein the building panel comprises a ceiling tile.

12. The building panel of claim 4 wherein the at least one aluminum salt is present in an amount ranging from approximately 0.1% to approximately 4.0% by weight of the building panel.

13. The building panel of claim 12 wherein the at least one aluminum salt is present in an amount ranging from approximately 0.4% to approximately 0.8% by weight of the building panel.

14. A ceiling tile the composition of which includes: at least one fibrous material; at least one filler material; and at least starch as a binder, the starch being distributed substantially uniformly through a thickness of the ceiling tile.

15. The ceiling tile of claim 14 wherein the at least one fibrous material is selected from the group consisting of mineral wool, slag wool, rock wool, stone wool, fiber glass and a cellulosic material and the at least one filler material is selected from the group consisting of calcium carbonate, clay, gypsum and expanded perlite.

16. The ceiling tile of claim 14 wherein the composition of the ceiling tile includes a coagulant for the starch.

17. The ceiling tile of claim 16 wherein the coagulant for the starch comprises at least one aluminum salt.

18. The ceiling tile of claim 17 wherein the at least one aluminum salt is selected from the group consisting of aluminum sulfate, polyaluminum chloride and sodium aluminate.

19. A method of producing a ceiling tile including:
providing a slurry comprising an aqueous dispersion of at least one fibrous material, at least one filler material, at least starch as a binder and a coagulant for the starch;
delivering the slurry onto a foraminous wire frame;
dewatering the slurry to form a basemat; and
drying the basemat to remove any residual moisture, whereby
the starch is distributed substantially uniformly through a thickness of the basemat and the ceiling tile and the starch included in the slurry is substantially retained in the basemat and in the ceiling tile.

20. The method of claim 19 wherein the coagulant comprises at least one aluminum salt.

21. The method of claim 20 wherein the at least one aluminum salt is selected from the group consisting of aluminum sulfate, polyaluminum chloride and sodium aluminate.

22. The method of claim 19 wherein the at least one fibrous material is selected from the group consisting of mineral wool, slag wool, rock wool, stone wool, fiber glass and a cellulosic material and the at least one filler material is selected from the group consisting of calcium carbonate, clay, gypsum and expanded perlite.

23. The method of claim 22 wherein the coagulant comprises at least one aluminum salt.

24. The method of claim 23 wherein the at least one aluminum salt is selected from the group consisting of aluminum sulfate, polyaluminum chloride and sodium aluminate.
